(19) United States
(12) Patent Application Publication
(10) Pub. No.: US 2008/0112070 A1
(43) Pub. Date: May 15, 2008

(54) FILTER WHEEL

(75) Inventors: Yasuhiro TANIBATA, Tokyo (JP); Taichirou NEZU, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/938,953

(22) Filed: Nov. 13, 2007

(30) Foreign Application Priority Data
Nov. 14, 2006 (JP) 2006-307989

(51) Int. Cl. G02B 5/22

(52) U.S. Cl. 359/891

(57) ABSTRACT

A filter wheel capable of executing continuous operation accurately is implemented. The filter wheel comprises a first pulley fixed to a rotation axle of a motor, a filter set table (a second pulley) on which a plurality of filters circularly arranged at equal intervals between a center axis and an outer periphery thereof are mounted, and a belt engaged with respective outer peripheries of the first pulley, and the filter set table, for conveying rotation of the motor to the filter set table through the intermediary of the first pulley, wherein upon an increase in diameter of the filter set table, due to a change in size of the filter, a third pulley is formed inside a space formed when the plurality of the filters are disposed in a circular fashion on the filter set table so as to be integral with the filter set table, the belt being engaged with the respective outer peripheries of the first pulley, and the third pulley.

### FIELD OF THE INVENTION

The invention relates to a filter wheel suitable for use in a confocal microscope comprising, for example, a microscope unit, and a confocal scanner unit, wherein excitation laser beams at a plurality of wavelengths are changed over by a excitation side filter means corresponding to the respective wavelengths before irradiating a specimen, and return fluorescent light beams from the specimen are caused to undergo image formation in an imaging means through the intermediary of a fluorescent observation side filter means capable of changing over the return fluorescent light beams so as to correspond to the respective wavelengths of the excitation laser beams.

### BACKGROUND OF THE INVENTION

A confocal microscope of Nipkow disk method has been disclosed in detail in JP 5-60980 A.

FIG. 6 is a functional block diagram showing a common system configuration of a confocal microscope by way of example. Reference numeral 1 denotes a multi-wavelength excitation light source for causing excitation light beams to outgo. Reference numeral 2 denotes a confocal scanner unit for allowing the excitation light beams from the multi-wavelength excitation light source 1 to selectively fall thereon. Reference numeral 3 denotes an inverted microscope unit connected to the confocal scanner unit, for use in fluorescence observation.

In the multi-wavelength excitation light source 1, reference numeral 1a denotes an ArKr (argon • krypton) gas laser, undergoing concurrent oscillations at wavelengths of 488 nm, and 568 nm, respectively. Those excitation light beams are caused to selectively fall on the confocal scanner unit 2 via an optical fiber 4. Reference numeral 1b denotes a semiconductor laser, oscillating at a wavelength of 405 nm. This excitation light beam is caused to fall on the confocal scanner unit 2 via an optical fiber 5.

Reference numeral 1c denotes an excitation side filter wheel, and the excitation light beams of the ArKr gas laser 1a are separated into ones at the two wavelengths of 488 nm, and 568 nm, respectively, by an excitation filter mounted in the excitation side filter wheel 1c, for transmitting only specific wavelength components, before being selectively emitted.

Reference numeral 1d denotes a shutter provided in the vicinity of an outgoing port of the semiconductor laser 1b for the excitation light beam at the wavelength of 405 nm, and this shutter is closed when the respective excitation light beams of the ArKr gas laser 1a are caused to fall on the confocal scanner unit 2, thereby preventing the specimen from being irradiated.

When the excitation light beam at the wavelength of 488 nm is guided from the ArKr gas laser 1a into the confocal scanner unit 2, it is possible to excite GFP (green fluorescent protein) or YFP (yellow fluorescent protein), and when the excitation light beam at the wavelength of 568 nm is guided, it is possible to excite DsRed (red fluorescent protein), and mRFP (monomer red fluorescent protein). Changeover of the excitation light beam can be executed by rotation of the excitation side filter wheel 1c, and a changeover speed is 125 msec at the maximum.

When the excitation light beam at the wavelength of 405 nm is guided from the semiconductor laser 1b into the confocal scanner unit 2, it is possible to excite DAPI (a kind of fluorescent reagent) or CFP (cyanide fluorescent protein).

Meanwhile, a filter wheel of a configuration shown in FIG. 7, for use on a fluorescence observation side as well as on an excitation side of the confocal microscope described in the foregoing, is well known.

In FIG. 7, reference numeral 20 denotes a filter wheel, 21 a filter holder for housing filters, 22 a first pulley disposed inside the filter holder 21 to be attached to a rotating shaft of a motor 25 fixed to the bottom of the filter holder 21. Reference numeral 23 denotes a filter set table (hereinafter referred to simply as a table) for use in attachment of the filter, provided side by side with the first pulley disposed inside the filter holder 21. The table 23 with teeth formed on the periphery thereof doubles as a second pulley.

Reference numeral 26 denotes each of four cap screws for adjustment of a position of the filter holder 21 in relation to the motor 25, 27 a photo-sensor for detecting rotation of the second pulley 23, and 28 an adjustment screw provided on the first pulley 22 side of the outer periphery of the filter holder 21, for fine adjustment of tightness of a toothed belt 32 stretched around the first pulley 22, and the second pulley 23. Reference numeral 35 denotes a cover of the filter holder 21, fixedly attached thereto with fixture screws 37.

In the configuration described as above, a command for rotation is issued to the motor 25 by a controller (not shown), the table (second pulley) 23 is rotated in association with rotation of the first pulley 22, and a filter (not shown) mounted on the table 23 is selected, whereupon analysis of a specimen, and so forth are executed. Further, in order to cause the rotation of the first pulley 22 to make quick response (for example, in 33 msec) to the table (second pulley) 23, the respective pulleys are formed so as to be identical in size of diameter.

However, with a structure of the filter wheel (for example, 18 mm in diameter) currently in use, if a filter is increased in size, for example, a filter diameter is increased to 25 mm, the table comes to have a diameter about 1.5 times as large as before, having mass increased about twice as large.

Further, the diameter of the first pulley 22, on the motor 25 side of the filter wheel 20, also becomes the same in size as that of the table (second pulley) 23. In such a case, if the same motor is used, it will become harder to effect startup stoppage of the motor because load torque, and moment of inertia are proportional to mass. Even if a motor with a larger torque is used, there has been a problem in that stable operation cannot be guaranteed under this condition.

### SUMMARY OF THE INVENTION

It is therefore an object of the invention to implement a filter wheel capable of executing continuous operation accurately, and stably at cycle time of 30 fps (frame/second), and at a speed not more than 33 msec even if a filter is of Φ 25 mm in size.

To that end, in accordance with a first aspect of the invention, there is provided a filter wheel comprising a first pulley fixed to a rotation axle of a motor, a filter set table (a second pulley) on which a plurality of filters circularly arranged at equal intervals between a center axis and an outer periphery thereof are mounted, and a belt engaged with respective outer peripheries of the first pulley, and the filter set table, for conveying rotation of the motor to the filter set table through the intermediary of the first pulley, wherein upon an increase in diameter of the filter set table, due to a change in size of the filter, a third pulley is formed inside a space formed when the plurality of the filters are disposed in a circular fashion on the filter set table so as to be integral with the filter set table, the belt being engaged with the respective outer peripheries of the first pulley, and the third pulley.

A rotation pulse is preferably given to a motor driver of the motor in three steps of acceleration time, steady-state drive time, and deceleration time while a startup frequency, drive frequency, acceleration time, and deceleration time are preferably set to predetermined values, respectively.

Teeth are preferably formed on the respective outer peripheries of the first pulley, and the third pulley, and teeth are preferably formed on the inner periphery of the belt.

For a material of at least one of components among the first pulley, the third pulley, and the filter set table, a member small in mass may be selected.

The member small in mass may be made of either an aluminum alloy or plastics.

As is evident from the foregoing description, the invention provided in its first aspect has the following advantageous effect.

When increasing the diameter of the filter set table as the size of the filter was changed, the third pulley was formed inside the space formed when the plurality of the filters were circularly disposed at equal intervals on the filter set table so as to be integral with the filter set table, and the belt was engaged with the respective outer peripheries of the first pulley, and the third pulley. As a result, it was possible to reduce the diameter of the third pulley, and to reduce the mass of the filter set table as compared with the case where the diameter of the first pulley was increased so as to match the size of the filter set table, so that an increase in load torque, and moment of inertia could be prevented.

Further, by combining the filter wheel with a stably operable motor, and adopting a three-step drive method, it was possible to implement quick changeover operation (for example, in 33 msec or less) of the filter set table with filters of a general-purpose filter size (for example, 25 mm in diameter) thereon.

Still further, while the teeth were formed on the respective outer peripheries of the first pulley, and the third pulley, the teeth were also formed on the inner periphery of the belt, and for material of the at least one of the first pulley, the third pulley, and the filter set table, use was made of either an aluminum alloy or plastics, so that it has become possible to execute fast operation without increasing a motor torque.

### BRIEF DESCRIPTION OF THE DRAWINGS

FIG. 1(A) is a plan view showing a configuration of one embodiment of a filter wheel according to the invention, and FIG. 11B) is a partly sectional elevation showing the configuration shown in FIG. 1(A);

FIGS. 2A to 2C each are a block diagram showing a configuration of a filter set table, and a third pulley, out of which FIG. 2(A) is a plan view, FIG. 2(B) is a sectional view taken on line X-X of FIG. 2(A), and FIG. 2(C) is a side view;

FIGS. 3A, 3B each are a view showing a relationship among the filter set table, the third pulley, and a first pulley;

FIG. 4 is a diagram for illustrating a drive state of a motor;

FIGS. 5A, 5B each are a schematic illustration, displaying a stabilization state of the filter set table, out of which FIG. 5(A) represents the case where the first pulley is increased in size so as to match the filter set table, and FIG. 5(B) represents the case of the embodiment of the invention;

FIG. 6 is a functional block diagram showing a common system configuration of a confocal microscope by way of example; and

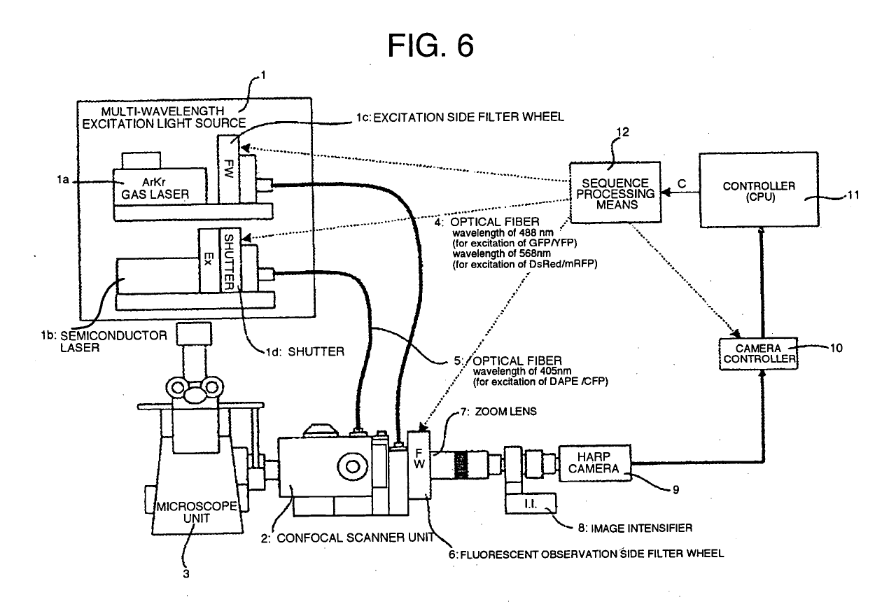

FIG. 7(A) is a plan view showing a configuration of a conventional filter wheel, and FIG. 7(B) is a partly sectional elevation showing the configuration shown in FIG. 7(A).

### PREFERRED EMBODIMENTS OF THE INVENTION

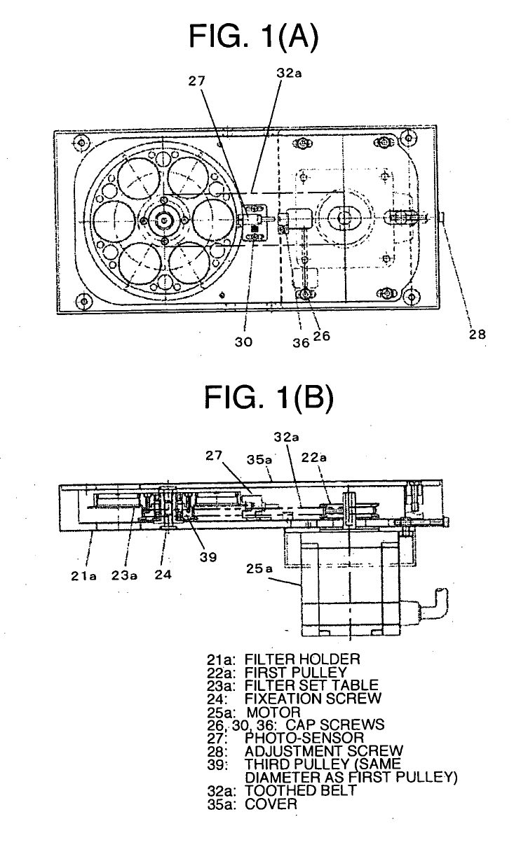

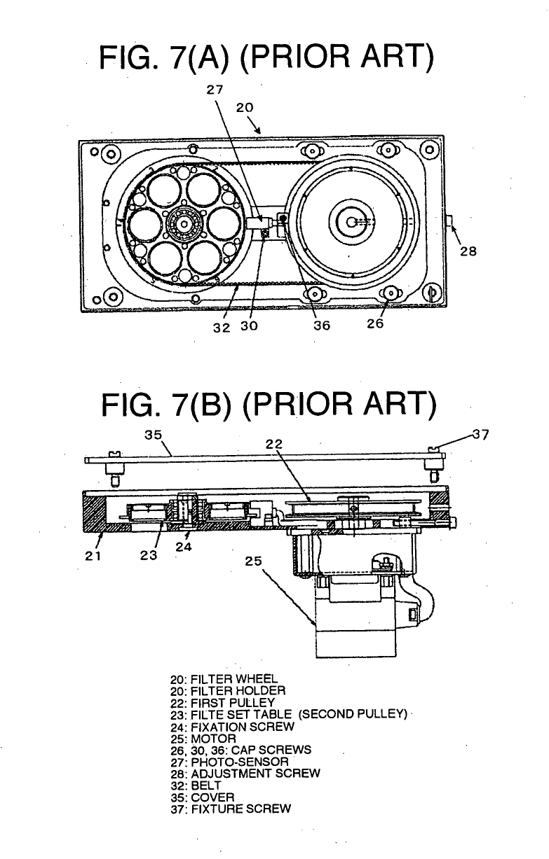

The invention is described in more detail hereinafter with reference to the accompanying drawings. FIG. 1 is a block diagram showing the principal part of one embodiment of a filter wheel according to the invention. In the figure, constituent elements identical to those in FIG. 7 are denoted by like reference numerals, thereby omitting duplicated description.

In FIG. 1, reference numeral 22a denotes a first pulley, and 39 a third pulley. The third pulley 39 is one corresponding to a case where respective diameters of filters mounted on a table 23a are increased in size from, for example, 18 mm to 25 mm. Further, the third pulley 39 is formed inside a space formed when a plurality of the filters (in the figure, 6 pieces of the filters 25 mm in diameter) are disposed in a circular fashion on the table 23a so as to be integral with the table 23a.

In this case, the diameter of the first pulley 22a is also changed so as to match that of the third pulley 39, and use is made of a toothed belt 32a matching in size to the respective diameters changed as above so as to be snugly engaged with the first pulley 22a, and the third pulley 39, respectively. Further, a motor 25a on the first pulley 22a side of the filter wheel is also changed, as necessary, to one with a larger torque.

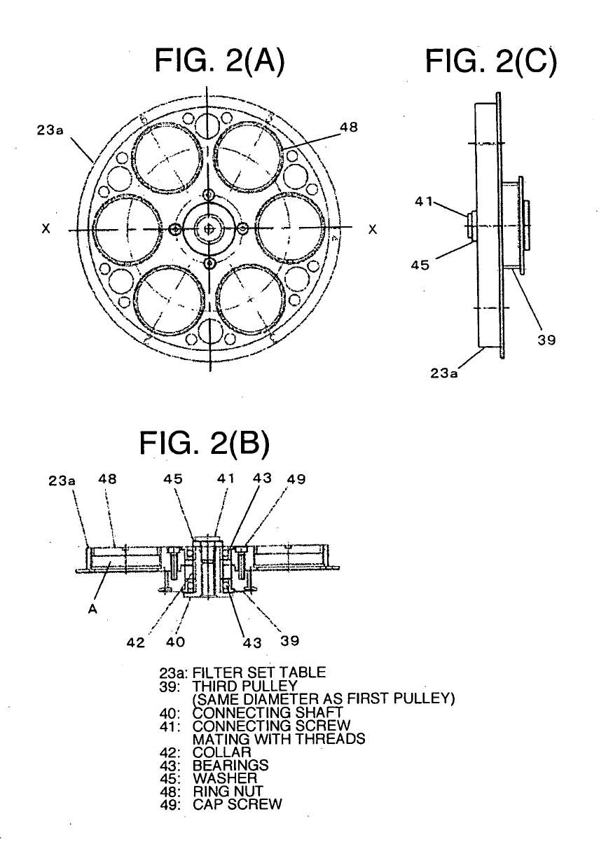

FIGS. 2A to 2C each are a block diagram showing details of the table 23a, and the third pulley 39, in the case where the 6 pieces of the filters 25 are fitted FIG. 2(A) is a plan view, FIG. 2(B) is a sectional view taken on line X-X of FIG. 2(A), and FIG. 2(C) is a side view. In those figures, reference numeral 48 denotes a ring nut for pressing down each of the filters to be secured to the table 23a. By screwing the ring nuts 48, the filters large in size (for example, 25 mm in diameter) are fixed to space A in the table 23a. The third pulley 39 is provided with teeth formed on the outer periphery thereof, and the toothed belt 32a is stretched around the third pulley 39 so as to be engaged with the first pulley 22a (refer to FIG. 1).

Reference numeral 49 denotes each of cap screws, for fixedly attaching the third pulley 39 to four spots of the table 23a. Reference numeral 40 denotes a connecting shaft reaching an upper surface of the table from the third pulley 39 side thereof. Reference numeral 41 denotes a connecting screw that can mate with threads formed on the inner periphery of the connecting shaft to thereby prevent a collar 42 from being pulled out. Reference numeral 43 denotes each of bearings disposed between the inner periphery of the third pulley and the collar.

With a makeup described as above, the table 23a is driven in rotation integrally with the third pulley 39.

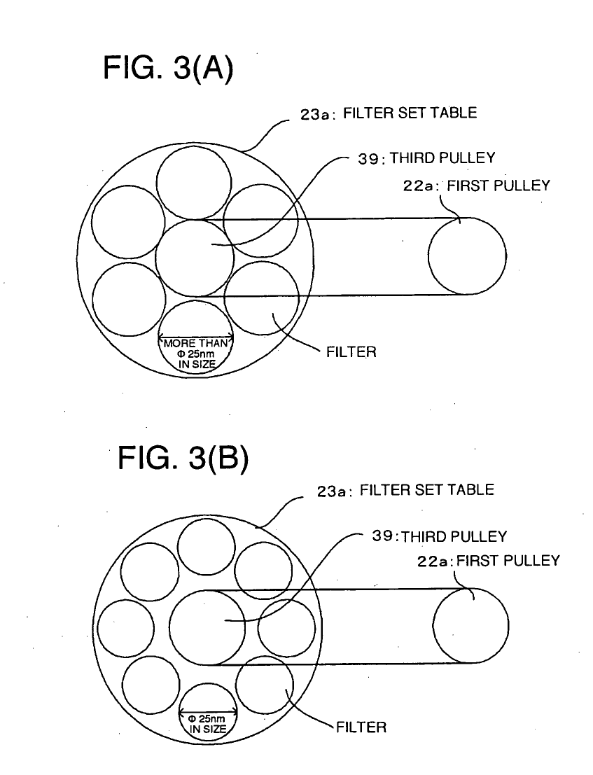

FIGS. 3A, 3B each are a view showing a relationship between the diameter of the first pulley 22a, and that of the third pulley 39, and FIG. 3(A) shows a case where six pieces of filters not less than 25 mm in diameter are mounted on the table 23a while FIG. 3(B) shows a case where eight pieces of the filters not less than 25 mm in diameter are mounted on the table 23a, in which case, the table 23a becomes greater in size than that in the case where the six pieces of the filters are mounted, and a space within the inner periphery of the table 23a also becomes greater, however, the diameter of the third pulley 39 remains the same as that in the case where the six pieces of the filters are mounted.

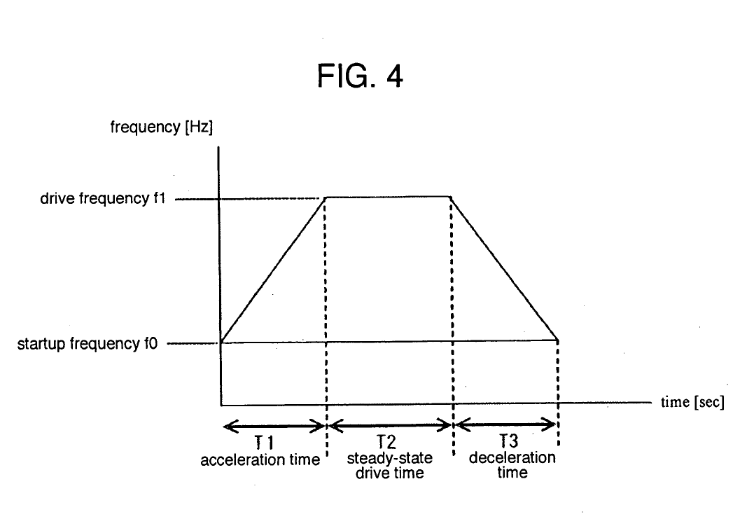

FIG. 4 is a diagram for illustrating a drive state of the pulse motor 25a for driving the first pulley 22a. In the figure, the vertical axis represents a pulse frequency applied to the pulse motor, and the horizontal axis represents pulse application time. As shown in the figure, a pulse is given to a motor driver in three steps of acceleration time (T1), steady-state drive time (T2), and deceleration time (T3). By setting a startup frequency, drive frequency, acceleration time, and deceleration time, at this point in time, to optimum values, respectively, stable and fast operation can be effected. Selection is made on a motor (for example, a step motor) that can be stably driven, small in mass as a small-diameter-pulley type motor as shown in the embodiment.

In FIG. 4, a pulse is generated at a frequency increasing at a predetermined acceleration rate from the startup frequency f0 to the drive frequency f1 during the acceleration time (T1).

Then, a pulse is generated at the constant drive frequency f1 during the steady-state drive time (T2), and a pulse is generated at a frequency decreasing at a predetermined deceleration rate from the drive frequency f1 to the startup frequency f0 during the deceleration time (T3).

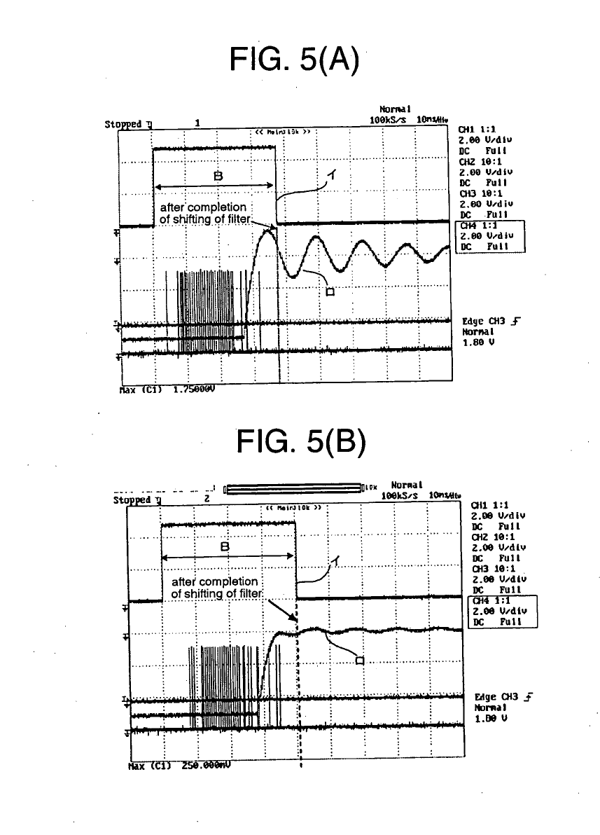

FIGS. 5A, 5B each are a view showing results of measurements with an oscilloscope, displaying an amplitude state until stabilization of the table, in which FIG. 5(A) represents the case where the first pulley 22a is increased in size so as to match the table 23a, and FIG. 5(B) represents the case of the embodiment of the invention. In those figures, a line segment (indicated by a symbol resembling the Japanese letter corresponding to “a”) shows pulse voltage at on/off, each division representing 2 V. A line segment (indicated by a symbol resembling the Japanese letter corresponding to “b”) shows position signal by a laser displacement gage, each division representing 1 mm (2 V corresponds to 1 mm).

Further, it is assumed in either case that pulse frequencies applied in the acceleration time, steady-state drive time, and deceleration time, respectively, are in the same state as described with reference to FIG. 4. Further, a range of the line segment, indicated by the letter B, corresponds to pulse application time, representing the case where when six pieces of filters are mounted, one of the filters is shifted toward the filter adjacent thereto through 60 degrees. If vibration is controlled within ±0.13 mm or less (within ±0.72 degrees by the rotation angle of the motor) after completion of the shifting of the filter by rotating the motor through 60 degrees, this will enable the filter wheel to be stably operated even during continuous operation at a high speed.

In the case where the first pulley 22a is increased in size so as to match the table 23a (FIG. 5(A)), it has taken long time for vibration as measured with the laser displacement gage, on the order of ±0.88 mm, to be attenuated to convergence, however, it is evident that in the case of the embodiment of the invention (FIG. 5 B), vibration has been attenuated to convergence within ±0.13 mm or less in short time.

Further, if the first pulley 22a, the third pulley 39, and the table are made of an aluminum alloy or plastics, small in mass, this will render it possible to achieve highly effective stabilization. Furthermore, it has been described hereinbefore that the filter wheel is suitable for use in the confocal microscope, however, the filter wheel is applicable to other optical components with filters mounted thereon.

Only a preferred embodiment of the invention with a certain degree of particularity has been shown as above for the purpose of description of the invention by way of example. Accordingly, it is to be understood that the invention is not limited to the embodiment described as above, and that various changes and modifications may be made in the invention without departing from the spirit or scope of the invention.

1. A filter wheel comprising:
a first pulley fixed to a rotation axle of a motor;
a filter set table (a second pulley) on which a plurality of filters circularly arranged at equal intervals between a center axis and an outer periphery thereof are mounted; and
a belt engaged with respective outer peripheries of the first pulley, and the filter set table, for conveying rotation of the motor to the filter set table through the intermediary of the first pulley;
wherein upon an increase in diameter of the filter set table, due to a change in size of the filter, a third pulley is formed inside a space formed when the plurality of the filters are disposed in a circular fashion on the filter set table so as to be integral with the filter set table, the belt being engaged with the respective outer peripheries of the first pulley, and the third pulley.

2. The filter wheel according to claim 1, wherein a rotation pulse is given to a motor driver of the motor in three steps of acceleration time, steady-state drive time, and deceleration time while a startup frequency, drive frequency, acceleration time, and deceleration time are set to predetermined values, respectively.

3. The filter wheel according to claim 1, wherein teeth are formed on the respective outer peripheries of the first pulley, and the third pulley, and teeth are formed on the inner periphery of the belt.

4. The filter wheel according to claim 1, wherein for material of at least one of components among the first pulley, the third pulley, and the filter set table, a member small in mass is selected.

5. The filter wheel according to claim 4, wherein the member small in mass is made of either an aluminum alloy or plastics.

6. The filter wheel according to claim 2, wherein teeth are formed on the respective outer peripheries of the first pulley, and the third pulley, and teeth are formed on the inner periphery of the belt.

7. The filter wheel according to claim 2, wherein for material of at least one of components among the first pulley, the third pulley, and the filter set table, a member small in mass is selected.

8. The filter wheel according to claim 3, wherein for material of at least one of components among the first pulley, the third pulley, and the filter set table, a member small in mass is selected.

9. The filter wheel according to claim 1, wherein the member small in mass is made of either an aluminum alloy or plastics.

10. The filter wheel according to claim 2, wherein the member small in mass is made of either an aluminum alloy or plastics.

11. The filter wheel according to claim 3, wherein the member small in mass is made of either an aluminum alloy or plastics.
